(19) United States
(12) Patent Application Publication
(10) Pub. No.: US 2026/0318318 A1
(43) Pub. Date: Oct. 15, 2026

(54) IMPELLER

(71) Applicant: LG ELECTRONICS INC., Seoul (KR)

(72) Inventors: Taekyung KIM, Seoul (KR); Jounyoung Kim, Seoul (KR); Jisu Hwang, Seoul (KR); Seongho Cho, Seoul (KR)

(21) Appl. No.: 19/465,300

(22) Filed: Jan. 30, 2026

(30) Foreign Application Priority Data
Feb. 5, 2025 (KR) 10-2025-0014467

(51) Int. Cl. F04D 29/28

(52) U.S. Cl. CPC F04D 29/281

(57) ABSTRACT

The present invention relates to an impeller including a hub installed on a rotational shaft, and a plurality of blades installed to extend outward from an inner side adjacent to the rotational shaft on one surface of the hub, wherein, when an inner end portion of the blade adjacent to the hub is referred to as a root and an outer end portion is referred to as a tip, at least one of the plurality of blades extends in a forward or reverse direction of an airflow so that at least a portion of the root is disposed to be spaced apart from the hub, thereby improving performance of the impeller.

### CROSS REFERENCE TO RELATED APPLICATION

The present application claims priority to Korean Patent Application No. 10-2025-0014467, filed Feb. 5, 2025, the entire contents of which is incorporated herein for all purposes by this reference.

### BACKGROUND OF THE INVENTION

### Field of the Invention

The present invention relates to an impeller, and more specifically, to an impeller capable of improving performance without changing the layout of the impeller.

### Description of the Related Art

A fan motor generates a suction force by rotating a fan (impeller) connected to a rotational shaft of the motor. The fan motor is used in various devices. The fan motor is used in home appliances, such as cleaners, air conditioners, and the like, vehicles, etc. For example, when the fan motor is used in the cleaner, air suctioned by the fan motor flows to a filter of the cleaner.

The fan motor typically includes a motor and an impeller connected to a rotational shaft of the motor. The impeller includes a rotatably installed hub and a plurality of blades coupled to the hub and forms a flow path between the blades.

A fluid is introduced into the center of rotation of the impeller through an inlet and pressed while flowing along the flow path within a space in which the blades are disposed. In addition, the pressed fluid flows radially around the impeller and is discharged to the outside of the impeller.

To increase a flow pressure of the fluid that has passed through the impeller or increase the amount of fluid suctioned into the impeller, a contact area between the fluid and the blades needs to be increased, and there is a need for a method of increasing an output of the impeller without increasing the overall volume of the impeller.

### SUMMARY OF THE INVENTION

The present invention has been devised to solve the problems of the conventional impellers and is directed to providing an impeller that enhances the performance of the impeller by increasing an air contact area of the blade without changing the layout of the impeller.

In addition, the present invention is directed to providing an impeller capable of increasing space utilization by providing a space in which nearby components may be inserted into a hub and reducing the overall axial length of a product in which the impeller is installed.

According to the present invention, there is provided an impeller including a hub installed on a rotational shaft, and a plurality of blades installed to extend outward from an inner side adjacent to the rotational shaft on one surface of the hub, wherein, when an inner end portion of the blade adjacent to the hub is referred to as a root and an outer end portion is referred to as a tip, at least one of the plurality of blades extends in a forward or reverse direction of an airflow so that at least a portion of the root is disposed to be spaced apart from the hub.

The blade may include a blade body, a leading edge positioned at an upstream end portion of the blade body with respect to a flow direction of air flowing along the blade body, and a trailing edge positioned at a downstream end portion of the blade body with respect to the flow direction of the air flowing along the blade body, and at least one of the plurality of blades may be disposed so that at least one of the leading edge and the trailing edge is spaced apart from the hub.

When a point at which the leading edge meets the root is referred to as a first point and a point at which the leading edge meets the tip is referred to as a second point, at least one of the plurality of blades may be formed such that the first point is disposed axially above an upper end of the hub and the second point is disposed axially above the first point.

The blade body may have a shortest length from a virtual horizontal line axially in contact with an uppermost end surface of the hub to the second point that is 15% or less of an axial length of the hub.

When a point at which the leading edge meets the root is referred to as a first point, at least one of the plurality of blades may be formed so that a diameter of a virtual circle connecting the first points about the rotational axis is smaller than a minimum diameter of the hub.

When a point at which the trailing edge meets the root is referred to as a third point and a point at which the trailing edge meets the tip is referred to as a fourth point, at least one of the plurality of blades may be formed so that a diameter of a virtual circle connecting the third points about the rotational axis of the hub is greater than a minimum diameter of the hub.

The blade may have a shortest distance from a virtual vertical line in contact with an outer surface of a maximum radius of the hub to the fourth point that is 15% or less of an axial length of the hub.

The blade body may be formed so that the leading edge is formed to be perpendicular or inclined with respect to the rotational shaft.

The blade body may be disposed so that the leading edge forms an angle of 50 degrees or more and 90 degrees or less with respect to the rotational shaft.

The blade body may be formed so that the trailing edge is formed to be parallel or inclined with respect to the rotational shaft.

The blade body may be disposed so that the trailing edge forms an angle of 0 degrees or more and 60 degrees or less with respect to the rotational shaft.

The hub may include a coupling portion fixed to the rotational shaft, and a hub body disposed to surround the coupling portion and provided with the plurality of blades, and the coupling portion may have an axial length that is shorter than an axial length of the hub body.

The coupling portion may have one end portion formed to have a step with one end portion of the hub body and the other end portion formed to have a step with the other end portion of the hub body.

In addition, at least one of the plurality of blades may include an extension in which at least one of one end and the other end extends in a forward or reverse direction of airflow with respect to a flow direction of air flowing along the blade and which is disposed outside the hub.

The blade may be disposed so that the root of the extension is spaced apart from the hub.

In addition, at least one of the plurality of blades may be disposed so that at least one of the leading edge and the trailing edge is spaced apart from the hub.

According to the impeller of the present invention, it is possible to enhance the performance of the impeller by increasing the air contact area of the blade without changing the layout of the impeller.

In addition, it is possible to increase space utilization by providing the space in which nearby components may be inserted into the hub and reducing the overall axial length of the product in which the impeller is installed.

### BRIEF DESCRIPTION OF THE DRAWINGS

FIG. 1 is a perspective view of a mixed-flow impeller according to an embodiment of the present invention.

FIG. 2 is a partial cross-sectional view of the mixed-flow impeller according to the embodiment of the present invention.

FIG. 3 is an enlarged view of a portion of FIG. 2 to describe a leading edge.

FIG. 4 is a cross-sectional view of the mixed-flow impeller according to the embodiment of the present invention.

FIG. 5 is an enlarged view of a portion of FIG. 4 to describe a trailing edge.

FIG. 6 is a perspective view of an expandable mixed-flow impeller having a long axial length to which blades according to a second embodiment of the present invention are applied.

FIG. 7 is a cross-sectional view of FIG. 6.

FIG. 8 is a perspective view of an expandable mixed-flow impeller having a long axial length to which blades according to a second embodiment of the present invention are applied.

FIG. 9 is a perspective view of an expandable mixed-flow impeller having a long axial length to which blades according to a second embodiment of the present invention are applied.

FIG. 10 is a perspective view of an axial impeller to which the blades according to the first embodiment of the present invention are applied.

FIG. 11 is a cross-sectional view of FIG. 10.

FIG. 12 is a perspective view of an axial impeller to which the blades according to the second embodiment of the present invention are applied.

FIG. 13 is a perspective view of an axial impeller to which the blades according to the third embodiment of the present invention are applied.

FIG. 14 is a perspective view of a different type of axial impeller to which the blades according to the first embodiment of the present invention are applied.

FIG. 15 is a cross-sectional view of FIG. 14.

FIG. 16 is a perspective view of a fan motor including the impeller of FIG. 14.

FIG. 17 is a partial cross-sectional view of FIG. 16.

### DETAILED DESCRIPTION OF THE INVENTION

Hereinafter, exemplary embodiments of the present invention will be described in detail with reference to the accompanying drawings.

Since the present invention may have various changes and various embodiments, specific embodiments are illustrated in the accompanying drawings and specifically described in the detail descriptions. This is not intended to limit the present invention to specific embodiments and should be construed to include all modifications, equivalents, and substitutes included in the spirit and technical scope of the present invention.

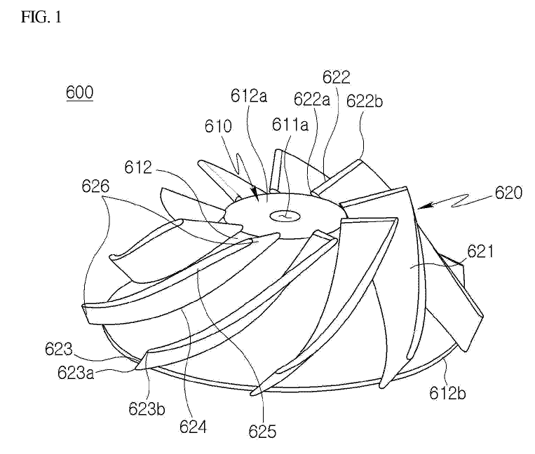

FIGS. 1 to 5 are views for describing an axial impeller according to an embodiment of the present invention.

A mixed-flow impeller 600 may suction air axially during rotation and blow the air in an oblique direction between axial and centrifugal directions.

The impeller 600 may include a hub 610 installed on a rotational shaft 111 and at least one blade 620 formed on an outer surface of the hub 610. The impeller 600 may generate a suction force to suction air while rotating about the center of the rotational shaft 111 during rotation of the rotational shaft 111 and suction air through an air inlet 411 of an impeller cover 400, which will be described below.

The hub 610 may be connected to an end portion of the rotational shaft 111 positioned inside the impeller cover 400. That is, the hub 610 may be coupled to an upper end of the rotational shaft 111. This hub 610 may include a coupling portion 611 and a hub body 612.

The coupling portion 611 is formed in a hollow shape and has a shaft coupling hole 611a in which the rotational shaft 111 is installed therein.

The hub body 612 is disposed to surround the coupling portion 611 and has at least one blade 620 provided on an outer surface thereof. The hub body 612 may be formed in a shape in which an outer diameter gradually increases toward one side in an axial direction. Specifically, the other axial end portion of the hub body 612 may be formed integrally with an end portion of the coupling portion 611 and formed in a shape in which an outer diameter gradually increases toward one axial side.

The hub 610 may be formed so that the outer diameter of one axial end portion close to the air suction port 411 formed on the impeller cover 400 is the smallest and the outer diameter of the other axial end portion away from the air suction port 411 is the largest. A maximum outer diameter of the hub 610 may be an outer diameter of an end portion opposite the air suction port 411 of both ends of the hub 610.

In addition, in the hub 610 of the mixed-flow impeller 600, one axial end surface may be an air suction surface 612a, and an outer surface of the other axial end portion having the maximum outer diameter may be an air discharge surface 612b.

A plurality of blades 620 may be formed on the outer surface of the hub 610, and the plurality of blades 620 may be disposed to be spaced apart from each other in a circumferential direction of the impeller 600.

The blade 620 may include a blade body 621, a leading edge 622, and a trailing edge 623. The blade body 621 may be formed in a plate shape with an inclined or curved shape and both surfaces thereof may include a pressure-side surface and a suction-side surface. The blade body 621 may be formed in a three-dimensional shape.

The blade body 621 may have a tip 625 positioned at the outermost side with respect to a center axis of the hub 610, and a root 624 positioned at the innermost with respect to the center axis of the hub 610.

In addition, the leading edge 622 is positioned at an upstream end (leading end) of the blade body 621 in a flow direction of air flowing along the blade body 621.

The trailing edge 623 is positioned at a downstream end (trailing end) of the blade body 621 in the flow direction of the air flowing along the blade body 621.

That is, the air first passes through the leading edge 622, flows along the blade body 621, and is discharged through the trailing edge 623.

In addition, in the blade body 621, the leading edge 622 and the trailing edge 623 may be connected to the tip 625 and the root 624. Among edges connecting the leading edge 622 to the trailing edge 623 of the blade body 621, an end adjacent to the hub 610 may be referred to as the root 624, and an end opposite thereof may be referred to as the tip 625.

In addition, in the shape of the impeller 600 in which the plurality of blades 620 are disposed, a generatrix connecting the tips 625 may be formed in a straight line or curve whose outer diameter increases from top to bottom in an axial direction, and an inner surface of the impeller cover 400, which will be described below, may be formed to correspond to the generatrix of the impeller 600. That is, the plurality of tips 625 are disposed to come into contact with the inner surface of the impeller cover 400 at a predetermined distance.

In the impeller 600 according to the present invention, at least one of the blade body 621 in contact with the leading edge 622 of at least one blade 620 and the blade body 621 in contact with the trailing edge 623 extends in a forward or reverse direction of the airflow and extends to protrude from an axial end surface of the hub 610. The blades 620 are disposed so that at least a portion of the root 624 of the blade body 621 is spaced apart from the hub 610, and the edges 622 and 623 of the extended portion are disposed to be spaced apart from the hub 610.

Accordingly, the blade body 621 is disposed so that a portion thereof comes into contact with the hub 610 and is disposed on the outer surface of the hub 610 and the remainder thereof is disposed not to come into contact with the hub 610. At an upstream side of the blade body 621, among the portions not in contact with the hub 610, the root 624 is disposed radially inward of an outer surface of the hub 610 having the smallest diameter. In addition, among the portions of the blade body 621 that do not come into contact with the hub 610, the root 624 is disposed radially inward of the outer surface of the hub 610 having the largest diameter.

That is, the blade body 621 includes at least one extension 626, and the extension 626 is disposed to protrude from the hub 610 without being in contact with the hub 610.

The extension 626 may be provided so that the leading end of the blade body 621 extends in a direction opposite to the airflow, or the trailing end of the blade body 621 extends in a forward direction of the airflow. In addition, the blade body 621 may include the extension 626 at the leading end, the trailing end, or both the front and trailing ends. In this case, the forward direction of the airflow is a direction in which air suctioned through the air suction port 411 flows along the blade body 621 and moves away from the air suction port 411.

In addition, the impeller 600 may include the blades 620 with the extensions 626 and the blades 620 without the extensions 626, and for example, the blades 620 with the extensions 626 and the blades 620 without the extensions 626 may be alternately disposed in the circumferential direction.

In addition, the extensions 626 are disposed so that at least a portion of the root is spaced apart from the hub 610 and protrude from the end of the hub 610 to be disposed outside the hub 610.

Accordingly, as an area of the blade body 621 of the blade 620 in contact with air increases, it is possible to increase flow pressure and a suction flow rate without increasing a volume of the impeller cover 400 accommodating the impeller 600. The extension 626, which extends from the blade body 621 and is spaced apart from the hub 610, may be disposed in an existing free space around the impeller cover 400, thereby using the space between nearby components.

For example, as illustrated in FIGS. 1 to 5, in the plurality of blades 620 provided in the impeller 600, both the blade body 621 in contact with the leading edge 622 and the blade body 621 in contact with the trailing edge 623 extend. However, although not illustrated in the drawings, in only some of the blades 620, the blade body 621 in contact with the leading edge 622 and the blade body 621 in contact with the trailing edge 623 extend.

First, the blade 620 in which the blade body 621 in contact with the leading edge 622 is extended will be described. The blade body 621 may have the leading end extending in the direction opposite to the airflow and extend in the axial direction of the hub 610 and the leading edge 622 positioned at the extended end portion. Accordingly, the leading edge 622 is disposed to be spaced apart from the hub 610, and specifically, disposed to be spaced apart from the air suction surface 612a of the hub 610 in the axial direction.

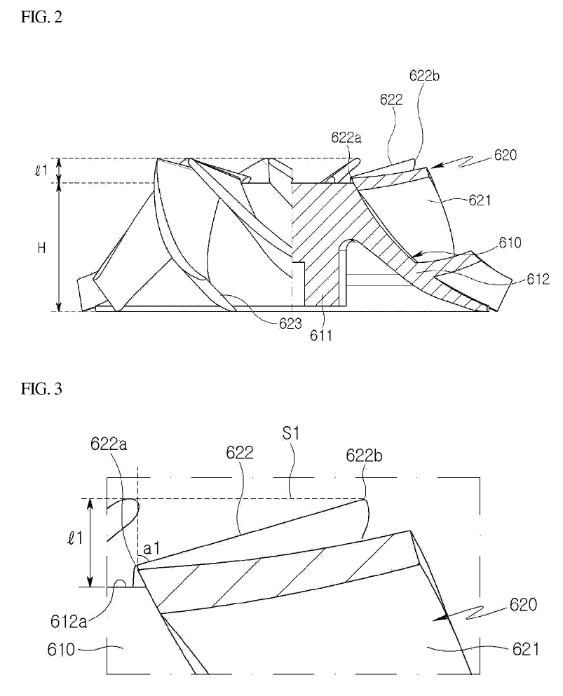

Referring to FIG. 2, when a point at which the leading edge 622 meets the root 624 is referred to as a first point 622a and a point at which the leading edge 622 meets the tip 625 is referred to as a second point 622b, and a virtual horizontal line in contact with the outermost side of the air suction surface 612a of the hub 610 is referred to as a first reference line, the first point 622a and the second point 622b may be disposed at one side in the axial direction from a virtual extension plane extending from the first reference line. In addition, the first point 622a may be disposed closer to the one axial side than the hub 610, and the second point 622b may be disposed closer to the one axial side than the first point. In the drawing, the first point 622a is positioned above the air suction surface 612a of the hub 610, and the second point 622b is positioned above the first point 622a.

The blade body 621 may be disposed so that an inner point of the leading edge 622 protrudes radially inward of the hub 610 as the leading end extends in the direction opposite to the airflow. That is, a diameter of the virtual circle connecting the first points 622a about the rotational axis 111 may be smaller than a minimum diameter of the hub 610.

In this case, the blade body 621 may be formed to extend by a preset length. Specifically, the blade body 621 is formed to extend by only the predetermined length so that a linear length ℓ1 from the virtual extension plane of the air suction surface 612a of the hub 610 to the second point 622b is 15% or less of an axial length H of the hub 610. Here, the axial length H of the hub 610 may be a distance from an upper end to a lower end of the hub 610.

In addition, referring to FIG. 3, the leading edge 622 may be disposed perpendicular to the rotational axis 111 of the hub 610 or disposed to be inclined with respect to the rotational axis 111 of the hub 610. Specifically, the leading edge 622 may be disposed to form an angle of 50 degrees or more and 90 degrees or less with respect to the rotational axis 111.

Accordingly, as an area of the blade body 621 of the blade 620 in contact with air increases, it is possible to increase flow pressure and a suction flow rate without increasing a volume of the impeller cover 400 accommodating the impeller 600.

Next, the blade 620 with the extended blade body 621 in contact with the trailing edge 623 will be described.

The blade body 621 may have the trailing end extending in the flow direction of the air and extending in an inclined direction of the outer surface of the hub 610 and the trailing edge 623 positioned on the extended end portion. Accordingly, the trailing edge 623 is disposed to be spaced apart from the hub 610, and specifically, disposed to be spaced apart from the air discharge surface 612b of the hub 610 in the axial direction.

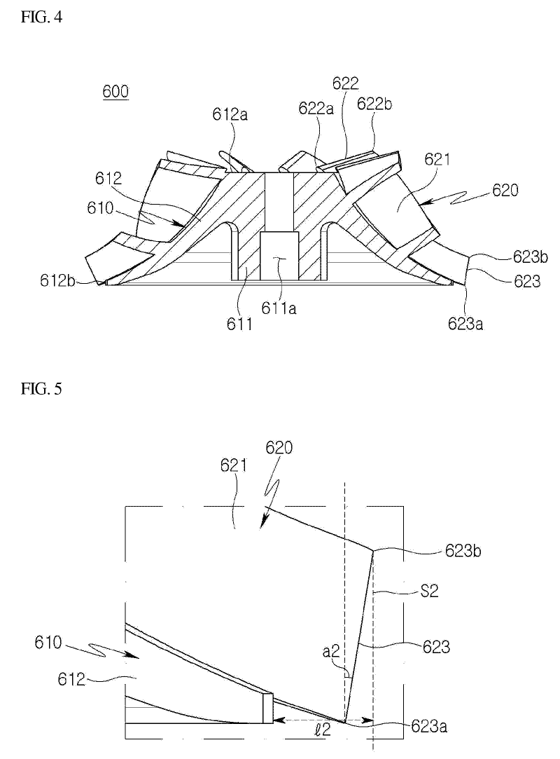

Referring to FIG. 4, when the point at which the trailing edge 623 meets the root 624 is referred to as a third point 623a and a point at which the trailing edge 623 meets the tip 625 is referred to as a fourth point 623b, a virtual vertical line in contact with the outermost side of the air discharge surface 612b may be referred to as a second reference line. In this case, the third point 623a and the fourth point 623b may be disposed radially outward of the hub 610 from the second reference line. That is, a diameter of a virtual circle connecting the third points 623a about the rotational axis 111 of the hub 610 may be greater than a maximum diameter of the hub 610.

In this case, the blade body 621 is formed to extend by a predetermined length, and specifically, a linear length ℓ2 from the virtual extension plane of the air discharge surface 612b of the hub 610 to the fourth point 623b is 15% or less of the axial length H of the hub 610.

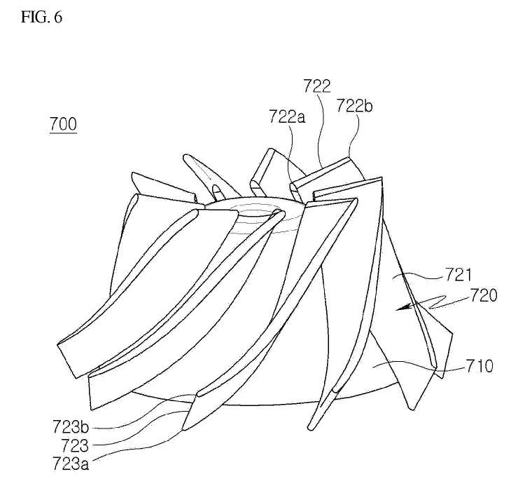

In addition, referring to FIG. 5, the trailing edge 623 may be disposed parallel to the rotational axis 111 of the hub 610 or disposed to be inclined with respect to the rotational axis 111 of the hub 610. Specifically, the trailing edge 623 may be disposed to form an angle of 0 degrees or more and 60 degrees or less with respect to the rotational axis 111.

Accordingly, as an area of the blade body 621 of the blade 620 in contact with air increases, it is possible to increase flow pressure and a suction flow rate without increasing a volume of the impeller cover 400 accommodating the impeller 600.

### Expandable mixed-flow impeller

FIGS. 6 to 9 are views for describing an expandable mixed-flow impeller having a long axial length according to an embodiment of the present invention.

Even in an expandable mixed-flow impeller 700, at least one of the plurality of blades 720 may have at least one of a leading end and trailing end extended so that at least one of a leading edge 722 and a trailing edge 723 may be positioned outside the hub 710.

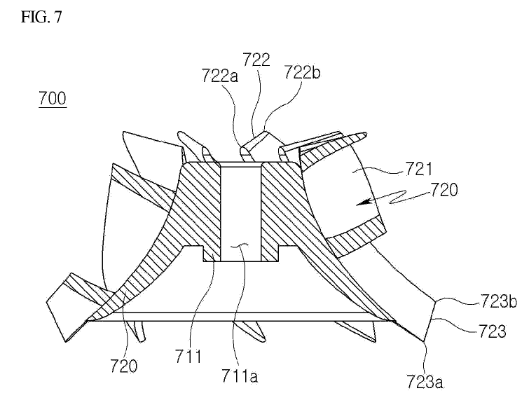

Referring to FIGS. 6 and 7, in the expandable mixed-flow impeller 700, a hub body 712 may be formed to axially extend compared to the hub body 612 of the typical mixed-flow impeller, and an axial length of the hub body 712 may be formed to be greater than an axial length of a coupling portion 711. For example, the hub body 712 may be formed in a shape in which a diameter gradually increases toward one axial side, and one end of the hub body 712 may be formed to have a step with respect to the coupling portion 711.

Accordingly, nearby components, such as bearings and the like, may be disposed in an internal space of the hub body 712 in which the coupling portion 711 is not disposed, thereby reducing the axial length of a fan motor and the like to which the impeller 700 is applied.

In the blade 720, the leading and trailing ends of the blade body 721 may be formed to extend in the forward or reverse direction of the airflow, and the leading edge 722 and the trailing edge 723 may be disposed to be spaced apart from the hub 710.

That is, when a point at which the leading edge 722 meets the root is referred to as a first point 722a and a point at which the leading edge 722 meets the tip is referred to as a second point 722b, the first point 722a is disposed away from the hub 710 and is disposed above the hub 710.

In addition, when a point at which the trailing edge 723 meets the root is referred to as a third point 723a and a point at which the trailing edge 723 meets the tip is referred to as a fourth point 723b, the third point 723a is disposed not adjacent to the hub 710 and is radially outward of an outer surface of the other axial end having a maximum outer diameter of the hub 710.

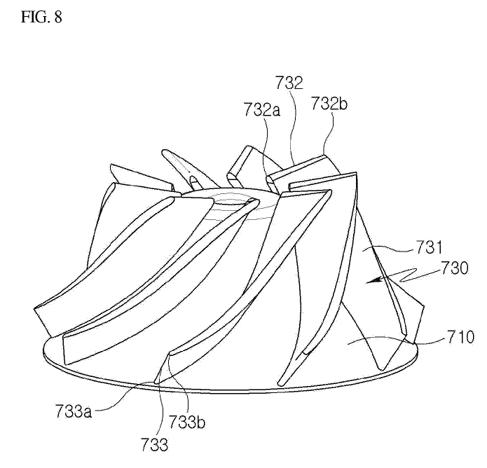

FIG. 8 illustrates the expandable mixed-flow impeller 700 to which blades 730 according to another embodiment are applied. According to FIG. 8, the blade 730 may be formed to have only a leading end extending in the flow direction of air, and the leading edge 732 of the blade body 731 may be disposed to be spaced apart from the hub 710.

That is, when the point at which the leading edge 732 meets the root is referred to as a first point 732a and a point at which the leading edge 732 meets the tip is referred to as a second point 732b, the first point 732a is disposed away from the hub 710 and is disposed above the hub 710.

That is, when a point at which the leading edge 733 meets the root is referred to as a first point 733a and a point at which the leading edge 733 meets the tip is referred to as a second point 733b, the first point 733a is disposed adjacent to the hub 710 and is disposed on an outer surface of the hub 710.

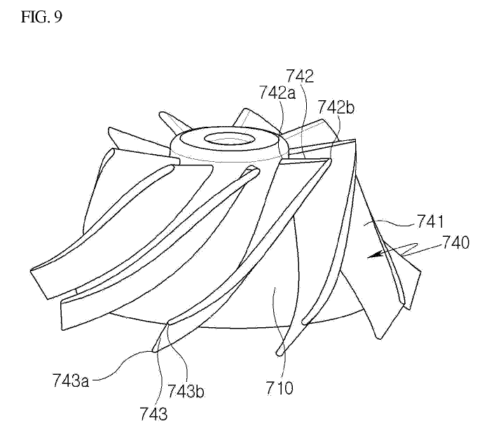

FIG. 9 illustrates an expandable mixed-flow impeller 700 to which blades 740 according to still another embodiment are applied. According to FIG. 9, the blade 740 may be formed to have only a trailing end extending in the flow direction of air, and the trailing edge 743 may be disposed to be spaced apart from the hub 710.

That is, when a point at which the leading edge 742 of the blade body 741 meets the root is referred to as a first point 742a and a point at which the leading edge 742 meets the tip is referred to as a second point 742b, the first point 742a is disposed adjacent to the hub 710 and is disposed on the outer surface of the hub 710.

In addition, when a point at which the trailing edge 743 meets the root is referred to as a third point 743a and a point at which the trailing edge 743 meets the tip is referred to as a fourth point 743b, the third point 743a is disposed away from the hub 710 and is radially outward of the outer surface of the other axial end having the maximum outer diameter of the hub 710.

### Axial impeller

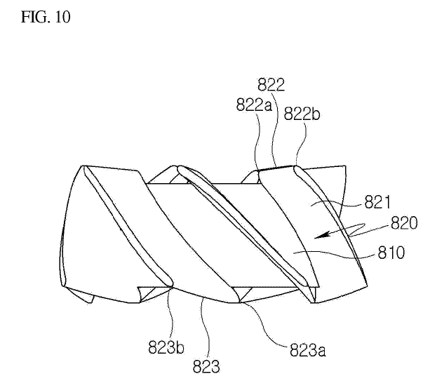

FIGS. 10 to 13 are views for describing an axial impeller according to an embodiment of the present invention.

An axial impeller 800 is an impeller that axially suctions air and axially blows the air during rotation.

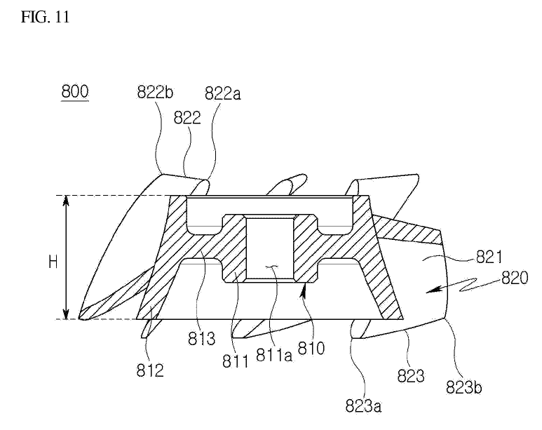

A hub 810 of the axial impeller 800 may include a coupling portion 811, a hub body 812, and a connection portion 813. Referring to FIG. 11, the coupling portion 811 has a shaft coupling hole 811a which is formed in a hollow shape and in which the rotational shaft 111 is installed. The hub body 812 is formed in a shape in which an outer diameter gradually increases toward one axial side, formed to have a slope closer to vertical than that of the mixed-flow impeller, is disposed to surround the coupling portion 811, and has at least one blade 820 provided on an outer surface thereof. Alternatively, an outer diameter of the hub body 812 may be formed vertically. The connection portion 813 may be disposed between the coupling portion 811 and the hub body 812 and formed integrally with the coupling portion 811 and the hub body 812.

In the hub 810, an axial length of the hub body 812 may be formed to be greater than an axial length of the coupling portion 811, and both end portions of the hub body 812 may be provided to have a step with both end portions of the coupling portion 811. That is, the coupling portion 811 may be provided so that one end portion has a step with one end portion of the hub body 812 and the other end portion has a step with the other end portion of the hub body 812. Accordingly, nearby components, such as bearings and the like, may be disposed in an upper or lower space of the coupling portion 811 within the inner space of the hub body 812 in the drawing.

In addition, in the hub 810 of the axial impeller 800, one axial end surface may be referred to as an air suction surface, and the other axial end surface may be referred to as an air discharge surface.

In addition, referring to FIGS. 10 and 11, in the blade 820, the leading and trailing ends of the blade body 821 may be formed to extend in the flow direction of air, and the leading edge 822 and the trailing edge 823 may be disposed to be spaced apart from the hub 810.

That is, when a point at which the leading edge 822 meets the root is referred to as a first point 822a and a point at which the leading edge 822 meets the tip is referred to as a second point 822b, the first point 822a is disposed away from the hub 810 and is disposed above the hub 810.

In addition, when a point at which the leading edge 823 meets the root is referred to as a third point 823a and a point at which the leading edge 823 meets the tip is referred to as a fourth point 823b, the third point 823a is disposed away from the hub 810 and is disposed below the hub 810.

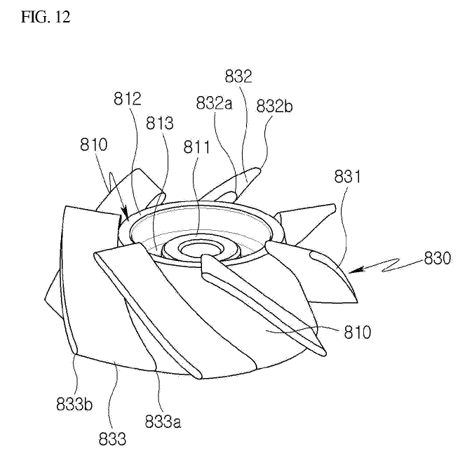

FIG. 12 illustrates the axial impeller 800 to which blades 830 according to another embodiment are applied. According to FIG. 12, in the blade 830, only the leading end may be formed to extend in the direction opposite to the airflow, and a leading edge 832 may be disposed to be spaced apart from the hub 810.

That is, when a point at which the leading edge 832 of the blade body 831 meets the root is referred to as a first point 832a and a point at which the leading edge 832 meets the tip is referred to as a second point 832b, the first point 832a is disposed away from the hub 810 and is disposed above the hub 810.

In addition, when a point at which the leading edge 833 meets the root is referred to as a third point 833a and a point at which the leading edge 833 meets the tip is referred to as a fourth point 833b, the third point 833a is disposed adjacent to the hub 810 and is disposed on the outer surface of the hub 810.

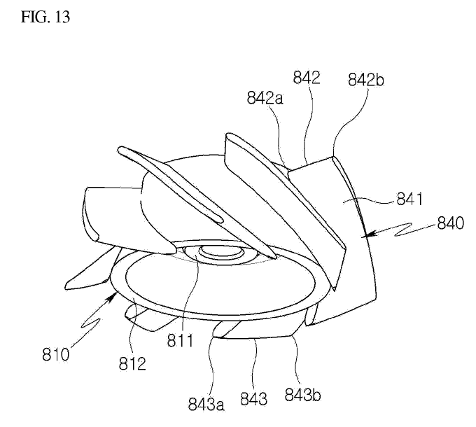

FIG. 13 illustrates the axial impeller 800 to which blades 840 according to still another embodiment are applied. According to FIG. 13, the blade 840 may be formed to have only a trailing end extending in the flow direction of air, and the trailing edge 843 may be disposed to be spaced apart from the hub 810.

That is, when a point at which the leading edge 842 of the blade body 841 meets the root is referred to as a first point 842a and a point at which the leading edge 842 meets the tip is referred to as a second point 842b, the first point 842a is disposed adjacent to the hub 810 and is disposed on the outer surface of the hub 810.

In addition, when a point at which the leading edge 843 meets the root is referred to as a third point 843a and a point at which the leading edge 843 meets the tip is referred to as a fourth point 843b, the third point 843a is disposed away from the hub 810 and is disposed below the hub 810.

### Different type of axial impeller

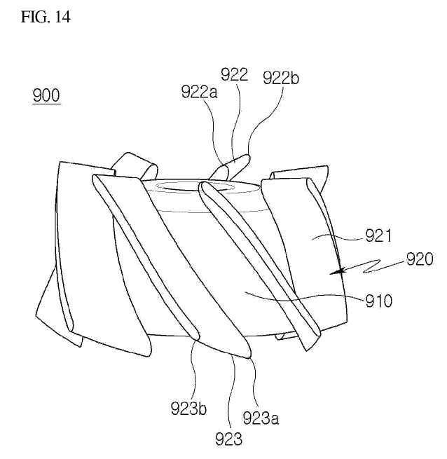

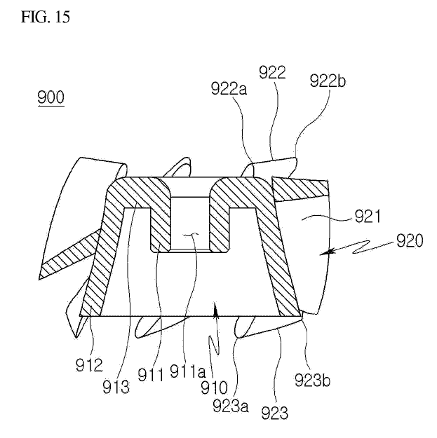

FIGS. 14 and 15 are views for describing a different type of an axial impeller according to an embodiment of the present invention.

An axial impeller 900 is disposed so that a connection portion 913 of the hub 910 connects an end portion of a coupling portion 911 to an end portion of a hub body 912. In the drawing, the hub 910 may be disposed to connect an upper end of the coupling portion 911 to an upper end of the hub body 912, and a space in which nearby components, such as bearings and the like, may be disposed may be provided below the coupling portion 911.

In addition, in a blade 920, leading and trailing ends of the blade body 921 may be formed to extend in the flow direction of air, and a leading edge 922 and a trailing edge 923 may be disposed to be spaced apart from the hub 910.

That is, when a point at which the leading edge 922 of the blade body 921 meets the root is referred to as a first point 922a and a point at which the leading edge 922 meets the tip is referred to as a second point 922b, the first point 922a is disposed away from the hub 910 and is disposed above the hub 910.

In addition, when a point at which the leading edge 923 meets the root is referred to as a third point 923a and a point at which the leading edge 923 meets the tip is referred to as a fourth point 923b, the third point 923a is disposed away from the hub 910 and is disposed below the hub 910.

### Fan motor

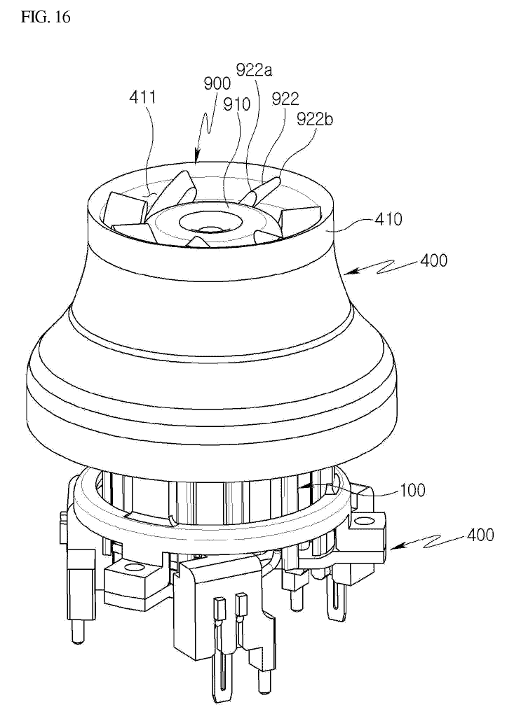

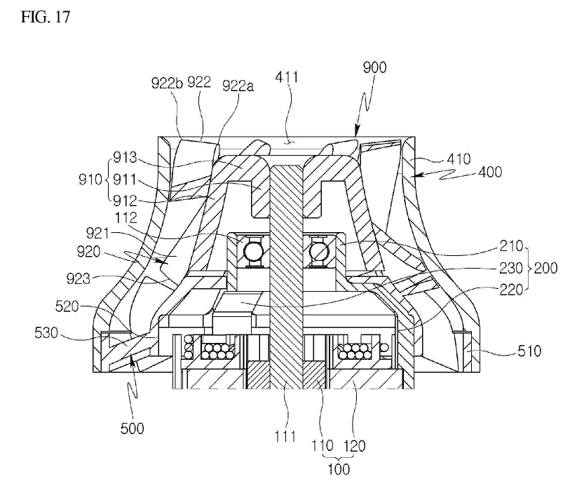

FIGS. 16 and 17 are views for describing a fan motor in which the impeller according to one embodiment of the present invention is installed.

The fan motor according to one embodiment of the present invention will be described with reference to FIGS. 16 and 17 as follows.

The motor 100 may include a stator 120 and a rotor 110. The rotor 110 may be rotatably positioned within the stator 120. The rotor 110 may be formed in a hollow cylindrical shape.

The rotor 110 may include a rotor core fixed to the rotational shaft 111 and a magnet installed on the rotor core.

The rotor 110 may be mounted to surround a portion between one axial end and the other axial end of the rotational shaft 111.

The rotational shaft 111 may rotate together with the rotor 110 and may be supported by bearings 112. The rotational shaft 111 may be rotated by the rotor 110 while supported by the bearings 112.

The impeller 900 may be connected to the rotational shaft 111, and during the rotation of the rotational shaft 111, the impeller 900 may rotate within the impeller cover 600. Accordingly, when the motor 100 rotates, the impeller 900 also rotates, generating a suction force to suction air.

The stator 120 may be mounted in a motor housing 300. The stator 120 may be mounted in the motor housing 300 and disposed to surround the rotor 110. The stator 120 may be fastened to the motor housing 300 using a fastening member, such as a screw or the like.

The stator 120 may be formed in a hollow cylindrical shape. The stator 120 may be mounted to surround the outer surface of the rotor 110.

The stator 120 may include a stator core, one or more insulators coupled to the stator core, and coils disposed on the insulators.

A motor bracket 200 may rotatably support an upper portion of the rotational shaft 111 of the rotor 110. In addition, a guide vane 500 may be coupled to an upper portion of the motor bracket 200. The motor bracket 200 may be coupled to the guide vane 500 to support the guide vane 500.

An upper bearing housing 210 may be provided in a central portion of the motor bracket 200. The upper bearing housing 210 may accommodate the upper bearings 112. The upper bearing housing 210 may be formed in a shape that accommodates the upper bearings 112. For example, the upper bearing housing 210 may be formed in a cylindrical shape. The upper bearing 112 may be disposed radially outward of the rotational shaft 111.

Meanwhile, the motor bracket 200 may be provided with a support 220. For example, the support 220 may be formed in a ring shape. In addition, the support 220 may have a predetermined height in a vertical direction.

In addition, a bridge 230 may be provided between the upper bearing housing 210 and the support 220. The bridge 230 may connect the upper bearing housing 210 to the support 220. That is, one side of the bridge 230 may be connected to the upper bearing housing 210, and the other side may be connected to the support 220. In this case, there is a height difference between the upper bearing housing 210 and the support 220. Accordingly, an upper end of the bridge 230 may be connected to the upper bearing housing 210, and a lower end thereof may be connected to the support 220.

A plurality of bridges 230 may be disposed outside the upper bearing housing 210 in the circumferential direction. The bridge 230 may have any shape as long as it serves to connect the upper bearing housing 210 to the support 220. For example, the bridge 230 may have a bar shape.

The motor housing 300 may accommodate at least a portion of the motor 100. The motor housing 300 may include a motor housing body 310, a lower bearing housing 320, and a connection portion 330.

The motor housing body 310 may accommodate one side of the motor 100 in a longitudinal direction. For example, the motor housing body 310 may accommodate a portion of a lower side of the motor 100.

The motor housing 300 may be connected to the motor bracket 200. Accordingly, the motor 100 may be accommodated in an internal space formed by connecting the motor housing 300 to the motor bracket 200.

The motor housing body 310 may have an overall hollow cylindrical shape. Air flowing into the motor 100 may be discharged to the outside of the motor housing body 310. For example, the air flowing into the motor 100 may be discharged to the outside through an opening formed in a lower portion of the motor housing body 310.

The lower bearing housing 320 in which the lower bearing 113 is seated may be provided below the motor housing body 310. The connection portion 330 connecting the lower bearing housing 320 to the motor housing body 310 may be provided.

Meanwhile, the stator 120 may be coupled to an inner surface of the motor housing body 310. The rotor 110 may be rotatably disposed in a central portion of the motor housing body 310. In this case, a lower portion of the rotational shaft 111 may be rotatably supported by the lower bearing housing 320.

Accordingly, an upper portion of the rotational shaft 111 may be rotatably supported by the upper bearing housing 210. In addition, the lower portion of the rotational shaft 111 may be rotatably supported by the lower bearing housing 320.

The guide vane 500 may be provided between the impeller 900 and the motor 100.

The guide vane 500 may guide the flow of air discharged from the impeller 900.

The guide vane 500 may include an inner wall 510, an outer wall 520, and vane blades 530. A plurality of vane blades 530 may be provided between the inner wall 510 and the outer wall 520 in the circumferential direction.

The inner wall 510 may be formed in a cylindrical shape with a partially closed upper end. An opening into which the upper bearing housing 210 of the motor bracket 200 is inserted may be formed in the inner wall 510. The shape of the opening in the inner wall 510 may correspond to the shape of the upper bearing housing 210. For example, the opening may be a circular hole.

At least a portion of the motor bracket 200 may be accommodated within the inner wall 510. In addition, the plurality of vane blades 530 may be formed on an outer surface of the inner wall 510 in the circumferential direction of the inner wall 510.

The outer wall 520 may be formed in a cylindrical shape. The outer wall 520 may be disposed radially outward of the inner wall 510.

The impeller cover 400 may accommodate the impeller 900 therein. The impeller cover 400 may be formed in a substantially hollow cylindrical shape. An opening of an upper portion of the impeller cover 400 may serve as the air suction port 411 through which air is introduced.

The impeller cover 400 may have a diameter that increases from top to bottom. A diameter of an outer surface of the impeller cover 400 may be equal to or slightly smaller than a diameter of an inner surface of the outer wall 520 of the guide vane 500. Accordingly, at least a portion of the outer surface of the impeller cover 400 may be coupled to the inner surface of the outer wall 520 of the guide vane 500.

The impeller 900 is installed on the rotational shaft 111 and disposed inside the impeller cover 400. The impeller 900 may be disposed in an upper space of the motor housing 300, and the hub 910 of the impeller 900 may be disposed to be spaced a predetermined distance from the motor housing 300.

In this case, since the impeller 900 is formed to have the leading and trailing ends of the blades 920 extending in the flow direction of air, the leading edge 922 may be formed to extend to the air suction port 411 of the impeller cover 400. An upper end portion of the impeller cover 400 may be provided to have a step with an upper surface of the hub 910, and the extended portion of the blade body 921 uses the space formed by the step, thereby increasing the output efficiency of the fan motor.

In addition, since at least a portion of the trailing edge 923 is disposed outside the motor housing 300, the extended portion of the blade body 921 is disposed in the remaining space between the impeller 900 and the guide vane 500, thereby further increasing the pressure of the discharged air.

Accordingly, a length of a flow path of the air flowing through the blade 920 increases, thereby improving the performance of the impeller and increasing the output efficiency of the fan motor.

The leading edge 922 may be positioned adjacent to the upper end portion of the impeller cover 400, thereby increasing the air suction flow rate and increasing output efficiency by increasing the contact area with the air.

Although the present invention has been described in detail through specific embodiments, this is intended to specifically describe the present invention, and it is apparent that the present invention is not limited thereto, and the present invention can be modified or improved by those skilled in the art without departing from the technical spirit of the present invention.

All simple modifications or changes of the present invention fall within the scope of the present invention, and the specific scope of the present invention will be made clear by the appended claims.

### DESCRIPTION OF REFERENCE NUMERALS

600: impeller

610: hub

611: coupling portion

612: hub body

620: blade

621: blade body

622: leading edge

622a: first point

622b: second point

623: trailing edge

623a: third point

623b: fourth point

624: root

625: tip

What is claimed is:

1. An impeller comprising:
a hub installed on a rotational shaft; and
a plurality of blades installed to extend outward from an inner side adjacent to the rotational shaft on one surface of the hub,
wherein, when an inner end portion of the blade adjacent to the hub is referred to as a root and an outer end portion is referred to as a tip,
at least one of the plurality of blades extends in a forward or reverse direction of an airflow so that at least a portion of the root is disposed to be spaced apart from the hub.

2. The impeller of claim 1, wherein the blade includes:
a blade body;
a leading edge positioned at an upstream end portion of the blade body with respect to a flow direction of air flowing along the blade body; and
a trailing edge positioned at a downstream end portion of the blade body with respect to the flow direction of the air flowing along the blade body, and
at least one of the plurality of blades is disposed so that at least one of the leading edge and the trailing edge is spaced apart from the hub.

3. The impeller of claim 2, wherein, when a point at which the leading edge meets the root is referred to as a first point and a point at which the leading edge meets the tip is referred to as a second point,
at least one of the plurality of blades is formed such that the first point is disposed axially above an upper end of the hub and the second point is disposed axially above the first point.

4. The impeller of claim 3, wherein the blade body has a shortest length from a virtual horizontal line axially in contact with an uppermost end surface of the hub to the second point that is 15% or less of an axial length of the hub.

5. The impeller of claim 2, wherein, when a point at which the leading edge meets the root is referred to as a first point,
at least one of the plurality of blades is formed so that a diameter of a virtual circle connecting the first points about the rotational axis is smaller than a minimum diameter of the hub.

6. The impeller of claim 2, wherein, when a point at which the trailing edge meets the root is referred to as a third point and a point at which the trailing edge meets the tip is referred to as a fourth point,
at least one of the plurality of blades is formed so that a diameter of a virtual circle connecting the third points about the rotational axis of the hub is greater than a minimum diameter of the hub.

7. The impeller of claim 6, wherein the blade has a shortest distance from a virtual vertical line in contact with an outer surface of a maximum radius of the hub to the fourth point that is 15% or less of an axial length of the hub.

8. The impeller of claim 2, wherein the blade body is formed so that the leading edge is formed to be perpendicular or inclined with respect to the rotational shaft.

9. The impeller of claim 2, wherein the blade body is disposed so that the leading edge forms an angle of 50 degrees or more and 90 degrees or less with respect to the rotational shaft.

10. The impeller of claim 2, wherein the blade body is formed so that the trailing edge is formed to be parallel or inclined with respect to the rotational shaft.

11. The impeller of claim 2, wherein the blade body is disposed so that the trailing edge forms an angle of 0 degrees or more and 60 degrees or less with respect to the rotational shaft.

12. The impeller of claim 1, wherein the hub includes:
a coupling portion fixed to the rotational shaft; and
a hub body disposed to surround the coupling portion and provided with the plurality of blades, and
the coupling portion has an axial length that is shorter than an axial length of the hub body.

13. The impeller of claim 12, wherein the coupling portion has one end portion formed to have a step with one end portion of the hub body and the other end portion formed to have a step with the other end portion of the hub body.

14. An impeller comprising:
a hub installed on a rotational shaft; and
a plurality of blades installed to extend outward from an inner side adjacent to the rotational shaft on one surface of the hub,
at least one of the plurality of blades includes an extension in which at least one of one end and the other end extends in a forward or reverse direction of airflow with respect to a flow direction of air flowing along the blade and which is disposed outside the hub.

15. The impeller of claim 14, wherein, when an inner end portion of the blade adjacent to the hub is referred to as a root and an outer end portion thereof is referred to as a tip,
the blade is disposed so that the root of the extension is spaced apart from the hub.

16. An impeller comprising:
a hub installed on a rotational shaft; and
a plurality of blades installed to extend outward from an inner side adjacent to the rotational shaft on one surface of the hub,
wherein the blade includes:
a blade body;
a leading edge positioned at an upstream end portion of the blade body with respect to a flow direction of air flowing along the blade body; and
a trailing edge positioned at a downstream end portion of the blade body with respect to the flow direction of the air flowing along the blade body, and
at least one of the plurality of blades is disposed so that at least one of the leading edge and the trailing edge is spaced apart from the hub.
